(19) United States
(12) Patent Application Publication
(10) Pub. No.: US 2006/0261507 A1
(43) Pub. Date: Nov. 23, 2006

(54) Method for producing a foamed article

(75) Inventors: Yoshitaka Kobayashi, Ichihara-shi (JP); Nobuhiro Usui, Ichihara-shi (JP)

Correspondence Address: FITCH, EVEN, TABIN & FLANNERY, P. O. BOX 65973, WASHINGTON, DC, 20035, US

(73) Assignee: Sumitomo Chemical Company, Limited, Tokyo (JP)

(21) Appl. No.: 11/257,133

(22) Filed: Oct. 25, 2005

(30) Foreign Application Priority Data
Oct. 27, 2004 (JP) 2004-311937

(51) Int. Cl. B29C 44/02

(52) U.S. Cl. 264/51; 264/53

(57) ABSTRACT

Disclosed is a method for producing a foamed article by injecting a molten polypropylene resin containing a foaming agent between cavity surfaces of a pair of a female and male molds having the cavity surfaces, wherein the molten polypropylene resin is injected between the cavity surfaces at an injection rate of from 200 cc/sec to 1200 cc/sec and a quotient of the longest flow distance of the molten resin between the cavity surfaces during a molding process divided by an injection time is 200 mm/sec or less.

### BACKGROUND OF THE INVENTION

1. Field of the Invention

The present invention relates to a method for producing a foamed article made of polypropylene resin.

2. Description of the Related Art

In late years, as automotive interior components such as door trims and instrument panels, articles made of thermoplastic resin are used. In particular, foamed articles made of polypropylene resin are used because of their good lightweight property. As a foamed article made of polypropylene resin, an article produced by injection molding, at a low temperature and at a high speed, of resin containing a chemical foaming agent is known (see, for example, JP 2003-11190 A).

However, foamed articles produced by conventional injection foam molding usually have on their surfaces a defect called “silver streak” and, therefore, are not always satisfactory with respect to their appearance. The “silver streak” referred to herein is a defectively cloudy condition which is generated when, during injection molding, gas foam contained in a molten resin flowing in the mold appears in the surface of the molded article.

### SUMMARY OF THE INVENTION

The present invention provides a method for producing a foamed article with good appearance made of polypropylene resin.

In one aspect, the present invention provides a method for producing a foamed article by injecting a molten polypropylene resin containing a foaming agent between cavity surfaces of a pair of a female and male molds having the cavity surfaces, wherein the molten polypropylene resin is injected between the cavity surfaces at an injection rate of from 200 cc/sec to 1200 cc/sec and a quotient of the longest flow distance of the molten resin between the cavity surfaces during a molding process divided by an injection time is 200 mm/sec or less.

In one preferred embodiment, at least one of the female and male molds has therein a molten resin feed conduit, one end of which opens as a resin feed gate in the cavity surface of the mold having the conduit, and the molten polypropylene resin is injected between the cavity surfaces via the molten resin feed conduit. In more preferable embodiment, the mold having the molten resin feed conduit has a heating mechanism which is capable of controlling the temperature of a molten polypropylene resin which flows in the conduit and the temperature of a wall of the conduit is controlled so that the temperature of a molten polypropylene resin which stays in or passes through the conduit is kept at a temperature of the resin at the time of its injection between the cavity surfaces. In another preferable embodiment, the resin feed gate has a switching mechanism for opening and closing the gate and wherein the switching mechanism is opened only at the time when the molten polypropylene resin is injected between the cavity surfaces. In a preferable embodiment, the resin feed gate has an opening area of from 0.03 cm² to 0.5 cm².

In another preferred embodiment, the foaming agent is a chemical foaming agent and the temperature of the molten polypropylene resin at the time of its injection between the cavity surfaces is set at a temperature not lower than a temperature at which, when the chemical foaming agent is heated at a rate of 5° C./minute, the chemical foaming agent finishes its decomposition.

In still another embodiment, a skin material is arranged between the cavity surfaces before the molten polypropylene resin is injected between the cavity surfaces. In this embodiment, a foamed article with a skin material which has been integrated to its polypropylene resin foamed body is obtained.

By use of the method of the present invention, it is possible to produce a foamed article with good appearance made of polypropylene resin.

### BRIEF DESCRIPTION OF THE DRAWINGS

FIG. 1 is a schematic view of an exemplary foamed article produced by the method of the present invention.

FIG. 2 is a schematic cross-sectional view of an exemplary foamed article produced by the method of the present invention.

FIG. 3 a schematic view of another exemplary foamed article produced by the method of the present invention.

FIG. 4 is a schematic view of another exemplary foamed article produced by the method of the present invention.

FIG. 5 is a schematic view of a cross section of a mold assembly to be used in the method of the present invention.

FIGS. 6-9 schematically illustrate steps of the method of the present invention.

FIG. 10 is a schematic view of an exemplary foamed article produced by the method of the present invention.

FIG. 11 is a diagram illustrating the result of the measurement of the amount of gas generated from a chemical foaming agent.

In the drawings, the signs have meanings shown below: 1: injection foamed article, 2: skin layer, 3: foamed core layer, 4: skin material, 5: female mold, 6: male mold, 7: resin feed gate, 8: molten resin feed conduit, 9: molten polypropylene resin, A-I: resin feed gates, and a-r: points where gloss and brightness were measured.

### DESCRIPTION OF THE PREFERRED EMBODIMENTS

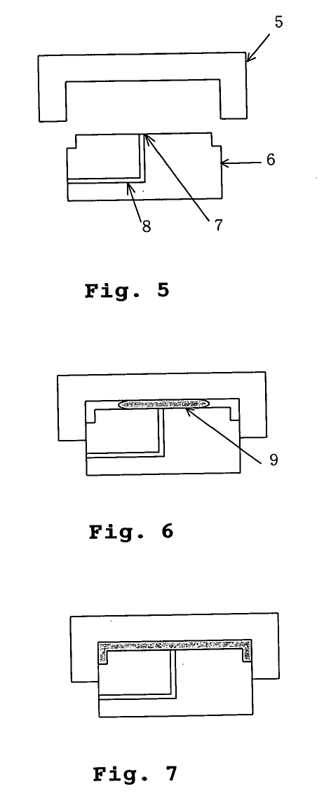

The present invention is described in detail below with reference to drawings. The following description is made to some examples of the present invention, but the invention is not limited to the examples. In addition, although an example in which the molds are moved vertically is illustrated in FIGS. 5-9, the direction of the mold movement may be horizontal.

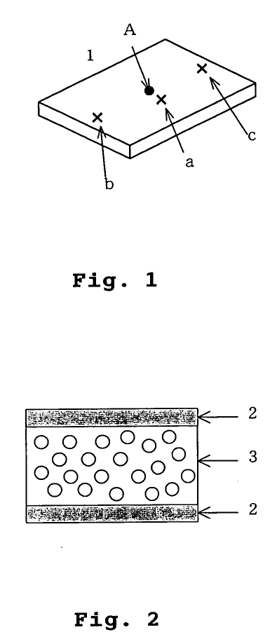

FIG. 1 shows a foamed article (1) produced by the method of the present invention. As shown in a cross sectional view in FIG. 2, the article is composed of a skin layer (2) having no or almost no voids, which forms the surface of the article, and a foamed core layer (3) having voids, which has been formed inside the skin layer. The foamed article may have, partly or wholly in its surface, an uneven pattern such as a grain pattern and a graphic pattern. The depth of the uneven pattern is typically from 10 μm to 500 μm, preferably from 50 μm to 200 μm. The foamed article has no particular limitation with respect to its size. However, the project area of the article viewed from the mold movement direction is preferably 0.1 m² or more, more preferably 0.2 m² or more.

The polypropylene resin applied to the method of the present invention may be composed only of a propylene homopolymer component, but it is preferably composed of a propylene homopolymer component and at least one ethylene-α-olefin copolymer component. Examples of the copolymer component include ethylene-propylene copolymer, ethylene-butene-1 copolymer, ethylene-hexene-1 copolymer and ethylene-octene-1 copolymer. Ethylene-propylene copolymer is preferred. Propylene-based block copolymers composed of a propylene homopolymer component and a copolymer component are preferable as the polypropylene resin.

The polypropylene resin may include additional resin or rubber such as polyethylene and aromatic vinyl compound-containing rubber. Specific examples of the aromatic vinyl compound-containing rubber include block copolymers such as styrene-ethylene-butene-styrene rubber (SEBS), styrene-ethylene-propylene-styrene rubber (SEPS), styrene-butylene rubber (SBR), styrene-butadiene-styrene rubber (SBS), styrene-isoprene-styrene rubber (SIS), and block copolymers resulting from hydrogenation of the foregoing block copolymers. Rubber prepared by reacting an aromatic vinyl compound such as styrene with an olefinic copolymer such as ethylene-propylene-nonconjugated diene rubber (EPDM) may also be used.

The content of the propylene homopolymer component in the polypropylene resin is preferably from 50 wt. % to 95 wt. % of the polypropylene resin. If less than 50 wt. %, the rigidity or heat resistance may be insufficient, whereas if it is more than 95 wt. %, the impact strength may be insufficient.

The polypropylene resin may contain filler such as inorganic filler. Moreover, it may contain additives such as pigment, lubricant, antistatic agent and stabilizer. Examples of the inorganic filler include calcium carbonate, barium sulfate, mica, crystalline calcium silicate, talc and fibrous magnesium oxysulfate. In particular, talc and fibrous magnesium oxysulfate are preferred.

Taking into consideration foaming efficiency and surface conditions of resulting foamed articles, the die swell of the polypropylene resin, as measured at 230° C., shear rate of 2430 sec⁻¹ and L/D of 40, is preferably from 1.1 to 1.3.

From the viewpoint of molding efficiency, the melt flow rate (MFR) of the polypropylene resin, as measured at 230° C., 2.16 kgf load, is preferably from 40 g/10 min. to 200 g/10 min.

From the viewpoint of the weight of resulting foamed articles, the specific gravity of the polypropylene resin is preferably up to 0.95.

In the production of a foamed article by the method of the present invention, chemical forming agents and physical foaming agents are available as the foaming agent. Specific examples of chemical foaming agents which may be used include inorganic foaming agents such as sodium bicarbonate, sodium carbonate, ammonium bicarbonate, ammonium carbonate, citric acid and sodium citrate; organic foaming agents such as nitroso compounds, e.g., N,N′-dinitrosopentamethylenetetramine, azo compounds, e.g., azodicarbonamide and azobisisobutyronitrile, sulfonyl hydrazides, e.g., benzenesulfonyl hydrazide, toluenesulfonyl hydrazide and diphenylsulfon-3,3′-disulfonyl hydrazide, and p-toluenesulfonyl semicarbazide. In typical cases, chemical foaming agents are handled in the form of masterbatch. Alternatively, physical foaming agents, such as carbon dioxide and nitrogen, may be employed in a compressed gas state or supercritical state. Physical foaming agents may be used alone or in combination with chemical foaming agents.

The type of the foaming agent may be determined in consideration of the melting temperature of the polypropylene resin to be used and the desired expansion ratio. Use of an inorganic chemical foaming agent is preferred. The amount of the foaming agent to be used is adjusted in consideration of the strength, density, etc. of the desired article, but it is typically from 0.1 to 5 parts by weight based on 100 parts by weight of the resin.

FIG. 5 shows a cross sectional view of an example of the mold assembly for the production of a foamed article. The drive unit of the molds is not shown. The mold assembly has a female mold (5) and a male mold (6). In this example, the male mold (6) has therein a molten resin feed conduit (8) through which molten polypropylene resin containing a foaming agent will be fed to the mold cavity. One end of the conduit opens, as a resin feed gate (7), in the cavity surface of the male mold (6). Another end of the molten resin feed conduit (8) is connected to a molten resin feeding unit (not shown) such as an injection machine. In the male mold (6), a heating mechanism is provided near the molten resin feed conduit (8). The resin feed gate (7) opening in the cavity surface desirably has a switching mechanism. The heating mechanism of the molten resin feed conduit is desirably an electric heater which has been disposed around the molten resin feed conduit so as to control the temperature of the molten resin passes through the conduit. It is desirable that the switching mechanism of the resin feed gate be a mechanism such that the conduit is closed and opened by moving a pin ahead and astern by hydraulic or air drive, the pin being installed in the molten resin feed conduit just below the resin feed gate. It is preferable that the switching mechanism be opened only at the time when the molten polypropylene resin is injected into the cavity space between the cavity surfaces.

The number and location of the resin feed gate(s) (7) may be determined appropriately depending on the shape and size of the desired foamed article. As to the size of the resin feed gate, the opening area of the gate is preferably from 0.03 cm² to 0.5 cm². When two or more resin feed gates are provided, it is desirable that all the gates have an opening area within the above range. If the opening area of the resin feed gate is smaller than 0.03 cm², a great flow resistance may occur at the gate, whereas if the opening area is larger than 0.5 cm², the expandable resin material may be foamed near the gate, resulting in defective appearance.

The mold assembly used in the method of the present invention has a press unit (not shown) including a drive unit, a stationary platen and a movable platen. One of the paired female and male molds is fixed to the stationary platen of the press unit and the other is attached to the movable platen. The movable platen is moved toward the stationary platen through the action of the drive unit. Thus, the molds are closed. The drive source of the drive unit may be either hydraulic pressure or an electric motor.

FIG. 6 shows a state where a molten polypropylene resin (9) containing a foaming agent is being fed between the male mold (6) and the female mold (5) through the resin feed gate (7) via the molten resin feed conduit (8).

In a preferable embodiment, the temperature of the wall of the molten resin feed conduit (8) is controlled so that the temperature of the molten polypropylene resin containing a foaming agent which stays in or passes through the conduit is kept at the temperature of the resin at the time when it is fed to between the molds. In a preferable embodiment, when the polypropylene resin is fed between the molds, the switching mechanism provided to the resin feed gate is opened and when feed of a predetermined amount of resin has been finished, the switching mechanism is closed.

It is desirable that the rate at which the molten polypropylene resin is injected into the cavity space between the male mold (6) and the female mold (5) be from 200 cc/sec to 1200 cc/sec and the quotient of the maximum flow distance of the molten resin during the molding process from the start to the completion of the resin feed divided by the injection time be not more than 200 mm/sec. More desirably, the rate at which the molten resin is injected is from 200 cc/sec to 700 cc/sec and the quotient of the maximum flow distance of the molten resin during the molding process divided by the injection time is not more than 180 mm/sec. The quotient of the maximum flow distance of the molten resin divided by the injection time is preferably not less than 50 mm/sec.

The maximum flow distance of a molten resin during the molding process is the longest distance among the distances from the resin feed gate to the edge of the molded article. The quotient of a flow distance of a molten resin divided by an injection time indicates an average flow rate of the molten resin. The quotient of the longest flow distance by the injection time indicates the maximum average flow rate during the molding process. In use of two or more gates, the greatest rate among the maximum rates at all the gates must be a rate such as that mentioned above.

The injection time means a time required for the whole mold cavity to be filled with a molten resin. For example, when a narrow cavity space is filled first with a molten resin injected and then additional resin is injected while the cavity is expanded, the injection time is not the time from the start to the completion of the feed of the whole resin but is the time before the narrow cavity space is filled first. When the resin is fed through two or more gates, the injection time is defined to be the time from a time point when the resin feed is started to a time point when the cavity space is completely filled with the resin first. When the resin feed is started at two or more gates with some time differences, the injection time is defined to be the time from a time point when the resin feed is started at the gate where the resin feed is started earliest to a time point when the cavity space is completely filled first.

In conventional injection foam molding processes, the injection rate of a molten resin containing a foaming agent is set high and a molten resin is filled into a cavity in a short time while a high resin pressure is maintained. As a result, the gas generated from the molten resin is hardly captured between the mold wall and the molten resin. However, even when a molten resin is fed at a high rate, it has been difficult to fill a cavity space with the resin without capturing the gas and thus silver streaks occur. In the present invention, by use of a low resin injection rate, it is possible to allow the gas generated from the molten resin to escape without capturing the gas between a mold wall and the resin. It, therefore, is possible to produce molded articles with good appearance.

When a chemical foaming agent is used, the temperature of the molten polypropylene resin (9) containing the chemical foaming agent at the time when the resin is fed between the molds is desirably a temperature not lower than the temperature at which, when a predetermined amount (one gram) of the chemical foaming agent is heated at a rate of 5° C./minute, the chemical foaming agent decomposes completely. The temperature at which a chemical foaming agent decomposes completely when the chemical foaming agent is heated at a rate of 5° C./minute is defined to be a heating temperature applied at the completion of increase in cumulative volume of the gas generated when the chemical foaming agent is heated at a rate of 5° C./minute. For example, in the case shown in FIG. 11, the temperature at which the decomposition of the chemical foaming agent is completed is 230° C. The volume of the gas generated from a chemical foaming agent is measured in the following way. First, a foaming agent is put in a sealable container. After fitting, to the sealable container, a quantity measuring tube connected to a gas buret and a bubble tube, the temperature in the system is elevated at a rate of 5° C./minute from room temperature and the volume (at normal pressure) of the gas generated is measured. When a foamed article is produced by use of a master batch of a chemical foaming agent, the above-mentioned measurement is carried out using the masterbatch.

The mold temperature used when the molten polypropylene resin containing a chemical foaming agent is fed is preferably 50° C. or higher because articles with good appearance are formed at such a temperature. From the viewpoint of appearance of resulting articles, the volume of the cavity formed by the female and male molds when the molten polypropylene resin containing a chemical foaming agent starts to be injected is preferably from 30% to 100% of the volume of the cavity formed when the whole amount of molten polypropylene resin has been fed.

In one desirable embodiment, a molten polypropylene resin is filled first into a cavity space while the female and male molds are clamped with a clamping force greater than the injection pressure of the molten polypropylene resin, and then the clamping force is reduced. Subsequently, the rest of resin is fed while the female and male molds are clamped with a clamping force lower than the feed pressure of the resin. In this case, the cavity space is expanded by the additional feed of resin.

In another desirable embodiment, a molten polypropylene resin is fed to a cavity space while the male and female molds are clamped with a clamping force lower than the injection pressure of the molten polypropylene resin. During the feed of the resin, the cavity space is expanded by the pressure of the resin. In such a case, it is also desirable to compress the cavity space slightly by increasing the clamping force.

FIG. 7 shows a state where the feed of the molten polypropylene resin has been completed. In this state, a primary cooling is carried out to form a skin layer with a predetermined thickness near the surface the molten polypropylene resin in contact with the cavity surface. The primary cooling time varies depending on the mold temperature and the temperature of the molten resin. It, however, is typically from 0.1 to 5 seconds.

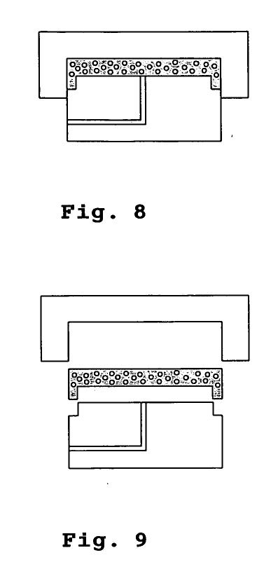

After the skin layer of the predetermined thickness is formed, expansion of the mold cavity along the thickness of a molded article as shown in FIG. 8 will cause expansion of the gas which generated through decomposition of a foaming agent and which has been trapped in an unsolidified portion of the molten polypropylene resin. Thus, the thickness of the article increases as a foamed layer grows. When the cavity clearance reaches the thickness of a desired product, the operation of cavity expansion is stopped. While the cavity clearance is maintained, the polypropylene resin foamed is allowed to cool and solidify.

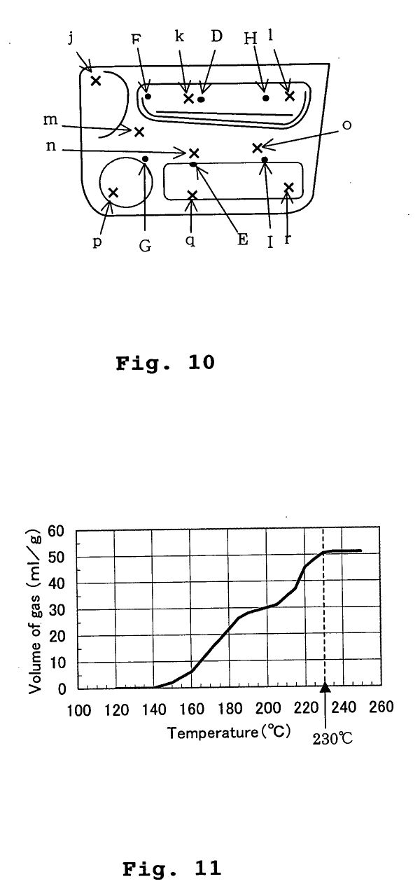

FIG. 9 shows a scene where the female and male molds are opened and the foamed article is removed. Thus, an injection foamed article like that shown in FIG. 1 is obtained.

In the case where a physical foaming agent or a combination of a chemical and physical foaming agents is used as the foaming agent, when the temperature of the molten resin during its injection between the molds is set to 250° C. or higher and the mold temperature to 60° C. or higher and the molten resin is injected between the molds at a rate like that previously described, it is possible to produce a foamed article with good appearance comparative to that in the case of using a chemical foaming agent alone.

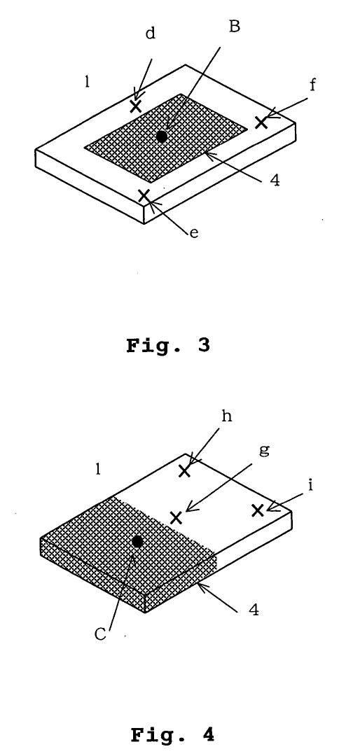

The present invention provides, in another aspect, a method for producing a foamed article having a skin material (4) laminated on at least a part of the surface thereof. The number of the skin material may be one or more. Two or more skin materials may be of the same type or of different types. The location of the skin material on the article is not particularly restricted and may be, for example, that shown in FIG. 3 or that shown in FIG. 4. The skin material may be integrated with a substrate, which is a foamed article, by welding it with the substrate during the production of the substrate or by impregnating it from its rear side with a molten resin for forming the substrate. Operations conducted in the production of the foamed article with a skin material are the same as those conducted in the case of using no skin material described previously except arranging a skin material between the female and male molds before the molten polypropylene resin is injected.

Examples of the skin material used in the present invention include woven fabric such as moquette, knitted fabric such as tricot, nonwoven fabric such as needle punched carpet, metal foil, and nonfoamed sheet or film of thermoplastic resin or thermoplastic elastomer. The skin material may be a laminated skin material having two or more layers including a lining layer such as a foam layer. Foam of polyolefin such as polypropylene and polyethylene, polyvinylchloride foam, rigid or semirigid polyurethane foam, etc. may be used as the foam layer.

As a lining layer other than the foam layer, nonwoven fabric, sheet or film of synthetic resin, and the like may be used. Examples of fiber forming the nonwoven fabric include natural fiber such as cotton, hair, silk and hemp, and synthetic fiber such as polyamide and polyester. Nonwoven fabric produced from one or more kinds of fiber is used. Examples of nonwoven fabric include needle punch nonwoven, spunbond nonwoven fabric, melt blown nonwoven fabric and spunlace nonwoven fabric.

Examples of the nonfoamed sheet or film of synthetic resin include nonfoamed sheet or film of thermoplastic resin such as polypropylene polyethylene or those of polyolefin-based thermoplastic elastomer.

By use of the method of the present invention, it is possible to produce foamed articles with a surface having an average of gloss (measuring angle: 60°) of 3.5 or less and a standard deviation of brightness of 0.6 or less, moreover, foamed articles with a surface having an average of gloss (measuring angle: 60°) of 2.5 or less and a standard deviation of brightness of 0.5 or less. When an injection foamed article having irregularities in its surface is produced by a conventional method, configuration of the cavity surface is transferred poorly to the surface of the article due to accumulation of gas between the surface of the article and the cavity surface, resulting in high gloss in an area where silver streaks have occurred. In an area where no silver streaks have occurred, the article has a low gloss. Moreover, in the area where silver streaks have occurred, the surface of the article may become whitish due to the accumulation of gas between the surface of the article and the cavity surface, resulting in a high brightness. In the area where no silver streaks have occurred, the brightness becomes low. Thus, when the brightness of the entire foamed article is measured, the standard deviation thereof is large. This means the foamed article has uneven appearance. Injection foamed articles produced by the method of the present invention have few silver streaks and, therefore, they are foamed articles with good appearance having low gloss (measuring angle: 60°) and a small standard deviation of brightness.

In foamed articles produced by conventional methods, silver streaks readily occur in edge portions of the articles and hardly occur near resin feed gates. When a foamed article is measured for its gloss, the gloss value measured at an edge portion of the article is large and the gloss value measured near a resin feed gate is small. Therefore, an average of gloss values at edge portions and gloss values near the resin feed gate is determined. The gloss is measured in accordance with JIS Z8741 using a gloss meter. When the brightness is measured at those points, the brightness values measured near the edge of a foamed article are large and those measured near a resin feed gate are small. The standard deviation determined on the basis of these measurements is large. Therefore, brightness is measured both near the edge and near a resin feed gate and a standard deviation is determined from those measurements. The brightness is measured in accordance with JIS Z8722 by use of a colorimeter whose measuring diameter is 50 mm.

The area “near a resin feed gate” is an area near a gate through which a molten polypropylene resin containing a foaming agent flows, during the production of a foamed article, into the cavity via a molten resin feed conduit provided in a mold. It specifically means a region within 30%, from the resin feed gate, of the distance from the resin feed gate to the flow end of the molten resin.

The area near the edge of a foamed article means an area outside the region within 70%, from the resin feed gate, of the distance from the resin feed gate to the flow end of the molten resin. For foamed articles produced by the method of the present invention, gloss and brightness are measured at three or more points in the surface of a foamed article, namely, one or more points near a resin feed gate, one or more points near the edge of the foamed article, and further one or more points near the resin feed gate or the edge of the foamed article. Then, an average of gloss and a standard deviation of brightness are calculated. For example, in a foamed article shown in FIG. 1, gloss and brightness are measured at three points, namely, point “a” near the resin feed gate “A”, and points “b” and “c” both near the edge of the foamed article.

In the case of a foamed article having thereon a skin material integrated to the body, gloss and brightness are measured at points outside the area on which the skin material is attached. In foamed articles, shown in FIG. 3 or FIG. 4, in which no resin feed gate is located outside the area where a skin material is attached, the site in the area where no skin material is attached which is closest to the resin feed gate is defined as the site near the resin feed gate. For example, in a foamed article shown in FIG. 3, gloss and brightness are measured at three points, namely, point “d” near the resin feed gate “B”, and points “e” and “f” both near the edge of the foamed article. For example, in a foamed article shown in FIG. 4, gloss and brightness are measured at three points, namely, point “g” near the resin feed gate “C”, and points “h” and “i” both near the edge of the foamed article.

As previously mentioned, for foamed articles produced by the method of the present invention, gloss and brightness are measured at three or more points in the surface of a foamed article, namely, one or more points near a resin feed gate, one or more points near the edge of the foamed article, and further one or more points near the resin feed gate or the edge of the foamed article. Then, an average of gloss and a standard deviation of brightness are calculated. It is preferable that gloss and brightness be measured further at optionally selected points in the surface of the foamed article, followed by calculations of an average of all the gloss values measured and a standard deviation of all the brightness values measured. When measurements are carried out at many points, it is desirable that the measuring points be located so that a measuring point is 200 mm, at most, apart from another measuring point.

When a plurality of resin feed gates are provided, it is required that gloss and brightness be measured near at least one gates. It, however, is preferable that gloss and brightness be measured near two or more gates. It is more preferable that gloss and brightness be measured near all the gates.

The expansion ratio of the injection foamed articles produced by use of the method of the present invention is not particularly limited, but it is typically from 1.1 to 5.

Since injection foamed articles produced by the method of the present invention are of light weight and of good appearance, they can be used as automotive interior or exterior components, interior or exterior components of household electric appliances, and building materials. In particular, they are useful as automotive interior or exterior components.

### EXAMPLES

[Measurement of Gloss]

The gloss was measured at a measuring angle of 60° in accordance with JIS Z8741 by using a gloss meter (Micro-TRI-Gloss manufactured by BYK-Gardner). The location of the measuring points are as shown in FIG. 10. Namely, the measurements were carried out at nine points, (k), (n) near resin feed gates D, E, and (j)-(r) including (j), (l), (p) and (r) close to the edge of the foamed article.

[Measurement of Brightness]

The brightness was measured in accordance with JIS Z8722 by using a chroma meter (CR210b manufactured by Minolta Co., Ltd., measuring diameter: 50 mm). The location of the measuring points are as shown in FIG. 10. Namely, the measurements were carried out at nine points, (k), (n) near resin feed gates D, E, and (j)-(r) including (j), (l), (p) and (r) close to the edge of the foamed article.

[Measurement of the Amount of Gas Generated from Chemical Foaming Agent]

In a sealable container, one gram of chemical foaming agent masterbatch was placed and a quantity measuring tube connected to a gas buret and a bubble tube was fitted to the sealable container. While the temperature was elevated from room temperature to 250° C. at a rate of 5° C./min, the volume of gas generated was measured.

[Measurement of Die Swell]

The die swell was measured under the conditions shown below using a Capirograph 1B manufactured by Toyo Seiki Seisaku-Sho, Ltd.

Measuring temperature: 230° C.

L/D: 40

Shear rate: 2430 sec⁻¹

[Measurement of MFR]

The MFR was measured according to the method provided in JIS K6758. The measurement was carried out at a temperature of 230° C. and a load of 2.16 kg, unless otherwise stated.

[Measurement of Specific Gravity]

The specific gravity was measured according to the method provided in JIS K7112.

[Material]

For injection molding used was a resin composition composed of a resin AU891E4 (polypropylene resin manufactured by Sumitomo Chemical Co., Ltd., MFR=80, die swell=1.20, specific gravity=0.89) and a chemical foaming agent masterbatch composed of 25 wt. % of sodium hydrogencarbonate, 25 wt. % of citric acid and 50 wt. % of low density polyethylene % by weight to chemical foaming agent, in amounts of 100 parts by weight of the resin and 2 parts by weight of the chemical foaming agent masterbatch. The chemical foaming agent masterbatch used had a relationship between the amount of gas generated and the temperature as shown in FIG. 11. The temperature at the completion of increase in cumulative volume of the gas generated was 230° C.

### Example 1

Injection molding was carried out using a mold assembly (project area: 0.5 m², gate diameter φ: 5 mm) for producing a molded article having a door trim shape shown in FIG. 10. In the mold assembly, the temperature of the molten resin feed conduit was controlled and each resin feed gate had a switching mechanism.

When the cavity clearance was 1.5 mm, a molten resin containing a foaming agent was started to be fed between the molds through two resin feed gates D, E (the maximum distance from the gates to the edge of the molded article was 470 mm) while the mold were pressed. While the cavity clearance was expanded to 2.0 mm, the feed of the molten resin was completed. Two seconds later, the mold cavity was expanded to a cavity clearance of 3.0 mm. Following to 30-second cooling, the molds were opened and the resulting foamed article was removed. The temperature of the molten resin when it was injected between the molds was 250° C. and the mold temperature was 60° C. The rate at which the molten resin was injected between the molds was 460 cc/sec. The injection time was 3.5 seconds. The compression pressure was 10 MPa. The results of measurements of the gloss of the surface of the foamed article are shown in Table 1. The results of measurements of the brightness are shown in Table 2. The foamed article had no silver streaks in its surface and had good appearance.

### Example 2

An injection foamed article was obtained in the same manner as Example 1 except that the injection temperature of the molten resin was 230° C. The results of measurements of the gloss of the surface of the foamed article are shown in Table 1. The results of measurements of the brightness are shown in Table 2. The foamed article had no silver streaks in its surface and had good appearance.

### Example 3

An injection foamed article was obtained in the same manner as Example 1 except that the injection temperature of the molten resin was 200° C. The results of measurements of the gloss of the surface of the foamed article are shown in Table 1. The results of measurements of the brightness are shown in Table 2. The foamed article had no silver streaks in its surface and had good appearance.

### Comparative Example 1

An injection foamed article was obtained in the same manner as Example 2 except that the injection rate of the molten resin was 800 cc/sec (injection time: 2.0 sec). The results of measurements of the gloss of the surface of the foamed article are shown in Table 1. The results of measurements of the brightness are shown in Table 2. The foamed article had silver streaks in its surface and had defective appearance.

TABLE 1

| | | | | Comparative |
|---|---|---|---|---|
| | Example 1 | Example 2 | Example 3 | Example 1 |
| Gloss (j) | 1.4 | 1.5 | 1.5 | 1.7 |
| Gloss (k) | 1.1 | 1.0 | 1.0 | 1.1 |
| Gloss (l) | 1.0 | 1.0 | 1.0 | 0.9 |
| Gloss (m) | 1.1 | 1.2 | 1.3 | 0.9 |
| Gloss (n) | 1.1 | 1.1 | 1.1 | 0.9 |
| Gloss (o) | 1.2 | 1.2 | 1.2 | 1.2 |
| Gloss (p) | 1.4 | 1.3 | 1.4 | 1.6 |
| Gloss (q) | 1.0 | 1.0 | 0.9 | 1.0 |
| Gloss (r) | 1.0 | 1.0 | 1.3 | 1.3 |
| Average of | 1.14 | 1.14 | 1.19 | 1.18 |
| gloss | | | | |
| Standard | 0.15 | 0.16 | 0.19 | 0.29 |
| deviation of | | | | |
| gloss | | | | |

TABLE 2

| | | | | Comparative |
|---|---|---|---|---|
| | Example 1 | Example 2 | Example 3 | Example 1 |
| Brightness (j) | 23.6 | 23.7 | 24.4 | 25.0 |
| Brightness (k) | 23.5 | 22.9 | 23.5 | 23.2 |
| Brightness (l) | 23.2 | 22.4 | 23.1 | 23.9 |
| Brightness (m) | 23.3 | 23.2 | 23.6 | 23.9 |
| Brightness (n) | 23.3 | 23.0 | 22.8 | 23.2 |
| Brightness (o) | 22.7 | 22.7 | 22.9 | 23.2 |
| Brightness (p) | 23.3 | 23.4 | 23.2 | 24.0 |
| Brightness (q) | 23.1 | 22.8 | 23.2 | 23.5 |
| Brightness (r) | 23.4 | 23.0 | 24.0 | 24.4 |
| Average of | 23.3 | 23.0 | 23.4 | 23.8 |
| brightness | | | | |
| Standard | 0.24 | 0.36 | 0.49 | 0.58 |
| deviation of | | | | |
| brightness | | | | |
| Presence of | No | No | No | Yes |
| silver streaks | | | | |

What is claimed is:

1. A method for producing a foamed article by injecting a molten polypropylene resin containing a foaming agent between cavity surfaces of a pair of a female and male molds having the cavity surfaces, wherein the molten polypropylene resin is injected between the cavity surfaces at an injection rate of from 200 cc/sec to 1200 cc/sec and a quotient of the longest flow distance of the molten resin between the cavity surfaces during a molding process divided by an injection time is 200 mm/sec or less.

2. The method according to claim 1, wherein at least one of the female and male molds has therein a molten resin feed conduit, one end of which opens as a resin feed gate in the cavity surface of the mold having the conduit, and the molten polypropylene resin is injected between the cavity surfaces via the molten resin feed conduit.

3. The method according to claim 2, wherein the mold having the molten resin feed conduit has a heating mechanism which is capable of controlling the temperature of a molten polypropylene resin which flows in the conduit and wherein the temperature of a wall of the conduit is controlled so that the temperature of a molten polypropylene resin which stays in or passes through the conduit is kept at a temperature of the resin at the time of its injection between the cavity surfaces.

4. The method according to claim 2, wherein the resin feed gate has a switching mechanism for opening and closing the gate and wherein the switching mechanism is opened only at the time when the molten polypropylene resin is injected between the cavity surfaces.

5. The method according to claim 2, wherein the resin feed gate has an opening area of from 0.03 cm² to 0.5 cm².

6. The method according to claim 1, wherein the foaming agent is a chemical foaming agent and the temperature of the molten polypropylene resin at the time of its injection between the cavity surfaces is set at a temperature not lower than a temperature at which, when the chemical foaming agent is heated at a rate of 5° C./minute, the chemical foaming agent finishes its decomposition.

7. The method according to claim 1, wherein a skin material is arranged between the cavity surfaces before the molten polypropylene resin is injected between the cavity surfaces.
